(19) United States
(12) Patent Application Publication
(10) Pub. No.: US 2005/0091343 A1
(43) Pub. Date: Apr. 28, 2005

(54) System, method and computer program product for network resource processing

(75) Inventor: William G. Murray JR., Redwood City, CA (US)

Correspondence Address: MICHAEL E. WOODS;PATENT LAW OFFICES OF MICHAEL E. WOODS, 112 BARN ROAD, TIBURON, CA, 94920-2602, US

(73) Assignee: BookFactory, LLC, Redwood City, CA (US)

(21) Appl. No.: 10/691,128

(22) Filed: Oct. 22, 2003

(51) Int. Cl. G06F 15/16

(52) U.S. Cl. 709/219

(57) ABSTRACT

Disclosed is a system, method and computer program product for remote processing of remote network resources. The system includes a user network device for locating a remote network resource; a network repository for storing the remote network resource at a remote location other than a local location of the user network device; and a network processor for receiving an identifier for the remote network resource from the user network device, the network processor operating, in response to a processing control from the user network device, on the remote network resource at a processing location other than the local location upon receipt of the identifier. The method for processing a network resource includes locating a remote network resource from a local location; sending an identifier for the remote network resource to a remote location; accessing the remote network resource at the remote location using the identifier; and processing the remote network resource at the remote location. The computer program product includes a computer readable medium carrying program instructions for initiating remote processing of a remote resource when executed using a computing system, the executed program instructions executing a method, the method includes a) identifying a resource identifier for the remote resource from a local process of the computing system; and b) communicating the resource identifier to a remote process to initiate a remote processing of the remote resource.

### BACKGROUND OF THE INVENTION

The present invention relates generally to document production, and more specifically to printing of a network resource at a remote printer with print finishing and shipping options configured at the remote printer by a local user.

The Internet includes a great number of network resources accessible by users of local network devices. These resources include web pages, documents, spreadsheets, presentations, sound files, image files, and the like. A user of a local network device is able to obtain a local copy of a particular one of these network resources from the Internet using an identifier. Providing a Uniform Resource Locator (URL) as the identifier is common since the URL is a standard used by many Internet applications including web browsers for locating and accessing a copy of a desired network resource. The prior art also uses the Universal Naming Convention (UNC) or the directory/file structure (DFS) as resource identifiers. These and other systems for specifying a particular resource available over private and public networks are included in the term “resource identifier.”

In well-known fashion, a process on a network device directly operated by a user (e.g., a web browser executing on a personal computer coupled to the Internet) locates a copy of a network resource and downloads a copy to a local memory of the local network device. Many processes include built-in (or add-in) viewers to format and present the network resource using the local network device. For example, the network resource may describe a web page in hypertext markup language (HTML) and the process receives the HTML and presents it on a display of the local network device. Other resources include documents in a particular word processing format (e.g., Corel® WordPerfect® or Microsoft® Word®), audio format (e.g., MP3), video (e.g., QuickTime, real audio, or AVI), still images (e.g., GIF, TIFF, or JPEG), or other resource type.

As discussed above, there are many different format types for different resources with some resource types having developed special viewer requirements. Some formats are so popular that they are a viewed as a “standard.” Viewers for such resources are easily obtained when appropriate viewers are not already incorporated into various processes of the local network device.

One such particularly useful format is a Portable Document Format (PDF) developed by Adobe Systems Incorporated, 345 Park Avenue, San Jose, Calif. 95110-2704. PDF permits a PDF-viewer (e.g., Adobe Acrobat) to present document content on a display associated with the local network device in virtually the same way as it would be presented if the content were printed. The pagination and content formatting of each page is preserved in the PDF without regard to the type of local printer or local display used in the viewing or printing of a document in PDF.

It is common for users of local network devices to operate the local network device and “surf” the Internet to locate one or more desirable network resources for local ‘consumption.’ These resources range widely and may be a document, a song, or a video clip, or any of the resources identified above. Once located, it is not uncommon for the user to desire to have a tangible version of the network resource such as a printed document or a compact disk (CD) having the song or video clip.

For many network resources, processing resources available to the local network device may be insufficient to efficiently produce the tangible version of the network resource. Some documents are very long, often using multiple colors, and may be formatted for a different medium-size than conventionally possessed by the local user. The more complicated the network resource is, the wider the disparity may be between the display characteristics of the resource and the ability of the user to produce a satisfactory tangible copy using the local resources. In some cases, the local resources may technically be capable of producing the tangible copy, but the production is inefficient or unsatisfactory more a variety of reasons. For example, for a document several hundreds of pages in length, consumer grade printers are typically too slow and unreliable to replicate each of the pages in sufficient quality. Also, many simple print finishing options like binding and glossy cover pages, much less more complicated finishing options such as book preparation or generation of tens to hundreds or more of copies of the content, are not practicable if available.

It is a further disadvantage when a web site provides resources to a user for review, printing, or access. The limited resources (local computer resources, printing/finishing and bandwidth) available to the users of the web site make it virtually impossible for the user to produce a desired exemplar of the web site document. First, the limited bandwidth may interfere with the user efficiently identifying the appropriate content because each sample may need to be downloaded to the user's local computer for review (provided that the user has enough free memory available to store a local copy). Second, the user then has a local copy of this document that is unlikely to be able to be used locally for the reasons set forth above. Third, many resources accessed from web sites have cryptic names that can be virtually impossible to remember, and since resources are downloaded to many different locations, and some of these locations are in multi-level subdirectories also having cryptic folder names, locating a particular local file accessed from the Internet can be extremely tedious if not nearly impossible.

This difficulty exists for others besides web site operators. Authors, publishers, distributors, and other owners/licensees of content have similar difficulties in making their content available in an appropriate electronic format, the concerns of digital rights management aside. It is a serious impediment to distribution when the user is unable to review and control production of a satisfactory copy of content, particularly for content that is likely to have been paid for. The user does not want poor quality paper, uneven images, blank or missing pages, or smudged toner marks on the pages, particularly when there may be nothing more than a rubber band to hold the stack of pages together, with a flat-tone black and white printed page as the cover.

The prior art has known the use of proprietary print drivers available to processes on a local network device. These drivers enable a user to operate on local content on the local network device and transmit the content in a special proprietary format to a remote device for further processing. This has been done with image and document resources created on the local network device. These solutions are disadvantageous for several reasons. The driver operates on the file using the local computer and uploads the reprocessed file to a production facility.

The proprietary driver is typically not incorporated into a commonly used resource production or editing process. A user is required to produce the resource (e.g., a document or image) using one process and use the proprietary driver to send the content with special formatting to a remote network device for further processing. The remote network device has a corresponding or compatible driver that attempts to accurately reproduce the formatting of the process on the local network device. It is often the case that there is not one hundred percent fidelity in reproducing the content formatting from the process using the proprietary drivers, and in certain cases the fidelity is much less than one hundred percent. An inability to guarantee fidelity has been a weakness in these solutions, and the chances of inaccuracy increases as new versions of resource producing processes are released having new features, and in some cases new resource formats. The proprietary driver typically is not available upon release of the new version, and the driver often still fails to produce a truly accurate reproduction after it becomes available. Users are then required to ensure that they have the right version of the proprietary driver installed to match their process, and they have to properly install the proprietary driver which is often a difficult task.

Another disadvantage of these types of prior art systems is that the content is moved from a local network device to a remote network device. While the use of broadband connectivity is not uncommon among users, connectivity speeds are based upon analog modem speeds for the larger share of users. Transmitting large files representing long or complex documents from a local network device to a remote network device will deter many users of these types of systems. Even for those users having a broadband connection, accessing and retrieving a very large file can be problematic. The Internet, connectivity, and the wide range of computing systems and application choices make transfer of very large file sizes difficult to implement reliably for a wide range of computing systems and software installations.

FIG. 1 is a schematic block diagram of a prior art Internet document printing system 100. System 100 includes a local computing system 105 connected to a local printer 110. Computing system 105 is coupled to an Internet Server 115 through a network 120, such as a wide-area network (e.g., the Internet or proprietary network) or a local area network. Internet Server 115 is coupled to a data repository 125 (e.g., a database) storing a plurality of network resources accessible by computing system 105 using an appropriate resource identifier (e.g., the URL).

There are many well-known ways that a user locates a particular one URL for access. Ultimately, the user sends a URL request from system 105 to server 115 using network 120. Server 115 makes a local request of data repository 125 using the URL to retrieve the requested document. Server 115 returns the resource to computer 105 over network 115. Computer 105 then sends the resource to printer 110 to generate the desired hardcopy of the resource. As discussed above, limitations in the connection capacity of computing system 105 to/from network 120, and limitations of printer 110 often limit the efficacy of system 100 for production of a document from a resource accessed through server 115.

Accordingly, what is needed is a system, method and computer program product for improved remote network resource processing as compared to the systems of the prior art. The present invention addresses such a need.

### SUMMARY OF THE INVENTION

Disclosed is a system, method and computer program product for remote processing of remote network resources. The system includes a user network device for locating a remote network resource; a network repository for storing the remote network resource at a remote location other than a local location of the user network device; and a network processor for receiving an identifier for the remote network resource from the user network device, the network processor operating, in response to a processing control from the user network device, on the remote network resource at a processing location other than the local location upon receipt of the identifier. The method for processing a network resource includes locating a remote network resource from a local location; sending an identifier for the remote network resource to a remote location; accessing the remote network resource at the remote location using the identifier; and processing the remote network resource at a remote location. The computer program product includes a computer readable medium carrying program instructions for initiating remote processing of a remote resource when executed using a computing system, the executed program instructions executing a method, the method includes a) identifying a resource identifier for the remote resource from a local process of the computing system; and b) communicating the resource identifier to a remote process to initiate a remote processing of the remote resource.

The preferred embodiment provides a simple and efficient system, method and computer program product for improved network resource processing of remote network resources. In the preferred embodiment, a user identifies a network resource that the user prefers to process remotely, and initiates the remote processing by sending the resource identifier (and in some cases locally derived parameters of the resource) to the remote processing device. In other embodiments, the user requests that a third party forward the link on their behalf to a remote configuration/processing process. In some implementations, the remote process may include preprocessing, processing, and post-processing operations on the resource. The remote process may include subprocesses: a configurator process for determining what processing a user desires to be performed on a remote resource, and one or more production processes that implements the requested action(s) on the resource. These remote processes may be performed by the same or different computer systems, just as the production processes may be performed on the same or different computer systems. The preferred embodiment has a processing for a remote resource initiated by sending some local data and a link to the remote resource to a first remote process that configures processing of the remote resource by a second process. An alternate preferred embodiment uses a processing authorization system (e.g., payment processing) to provide the user with a pay-as-you-go resource processing (e.g., printing) service for manufacturing (e.g., printing/binding/finishing) and delivering a desired quantity and quality of documents from the remote resource.

### BRIEF DESCRIPTION OF THE DRAWINGS

FIG. 1 is a schematic block diagram of a prior art Internet document printing system;

FIG. 2 is a schematic block diagram of a remote resource processing system according to a preferred embodiment of the present invention;

FIG. 3 is an overview flow diagram for a preferred remote resource process;

FIG. 4 is a detailed flow diagram for a preferred remote resource printing processing;

FIG. 5 is a screenshot of a process on a local computing system for reviewing network resources;

FIG. 6 is a portion of the screenshot shown in FIG. 5 illustrating a remote processing trigger incorporated into a control structure of the process;

FIG. 7 is a screenshot of the process shown in FIG. 5 after accessing a remote network resource;

FIG. 8 through FIG. 10 are a series of screenshots illustrating the setup of the remote processing of the network resource illustrated in FIG. 7 after actuation of the remote processing trigger shown in FIG. 6;

FIG. 8 is a screenshot of a PDF printing configurator screen;

FIG. 9 is a screenshot of a PDF printing confirmation screen previous to entering into a web store; and

FIG. 10 is a screenshot of a confirmation from the web store that payment was successful and that the requested processing has been authorized.

### DETAILED DESCRIPTION

The present invention relates to improved remote network resource processing. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

The present invention relates to processing of remote network resource at a location remote from a local network device where a user locates and identifies a particular resource at the local device. The terms processing, local network device, and remote network resources are used in the broadest sense consistent with disclosure herein. However, simply as an aid to understanding the present invention, the following description will be made detailing a preferred embodiment as it relates to remote printing/binding/finishing of documents identified by a URL and reviewed on a user's personal computer.

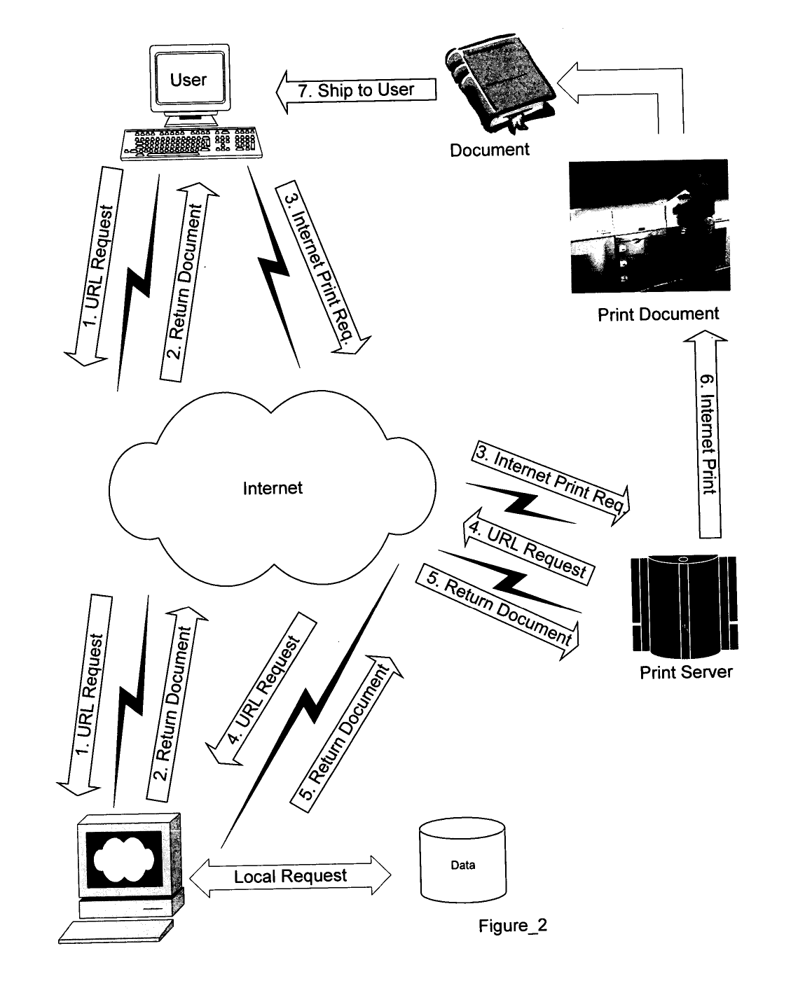

FIG. 2 is a schematic block diagram of a remote resource processing system 200 according to a preferred embodiment of the present invention. System 200 includes a local network device 205 (e.g., a personal computer) coupled through a network 210 to an Internet Server 215 coupled in turn to a data repository 220 and to an Internet Print Server 225. Print Server 225 is coupled to a document generator 230 (e.g., a printer) that includes various formatting and finishing options to generate finished document 235. Data repository 220 is preferably implemented as a file system structure, but other storage systems are possible such as a database or other file storage systems. Document generator 230 is preferably a high-speed commercial printer(s) having necessary features and options to print/bind/finish documents consistent with the system offerings. In the preferred embodiment, it is preferable that black & white and color images be able to be generated on different types and sizes of paper, bound and finished with typical options provided as anticipated for the target customer group.

In operation, a user locates a desired URL in any of several well-known ways such as an Internet search engine or specific referral from some other source. The user operates device 205 to issue a URL request through network 210 to server 215. Server 215 retrieves a copy of the desired document from repository 220 and returns the document to device 205 through network 210.

Next, the user initiates an Internet print request to Internet Print Server 225 through network 210 by sending Server 225 the URL and, in some instances, some locally derived document parameters. Server 225 next issues a URL request through network 210 to server 215. Server 215 retrieves a copy of the desired document from repository 220 and returns the document to Server 225 through network 210.

After receiving the document from Server 215, Print Server 225 sends the local copy of the document to document generator 230 to be manufactured into the desired quantity of formatted and produced hard copy documents 235. Document(s) 235 are delivered as the user desires.

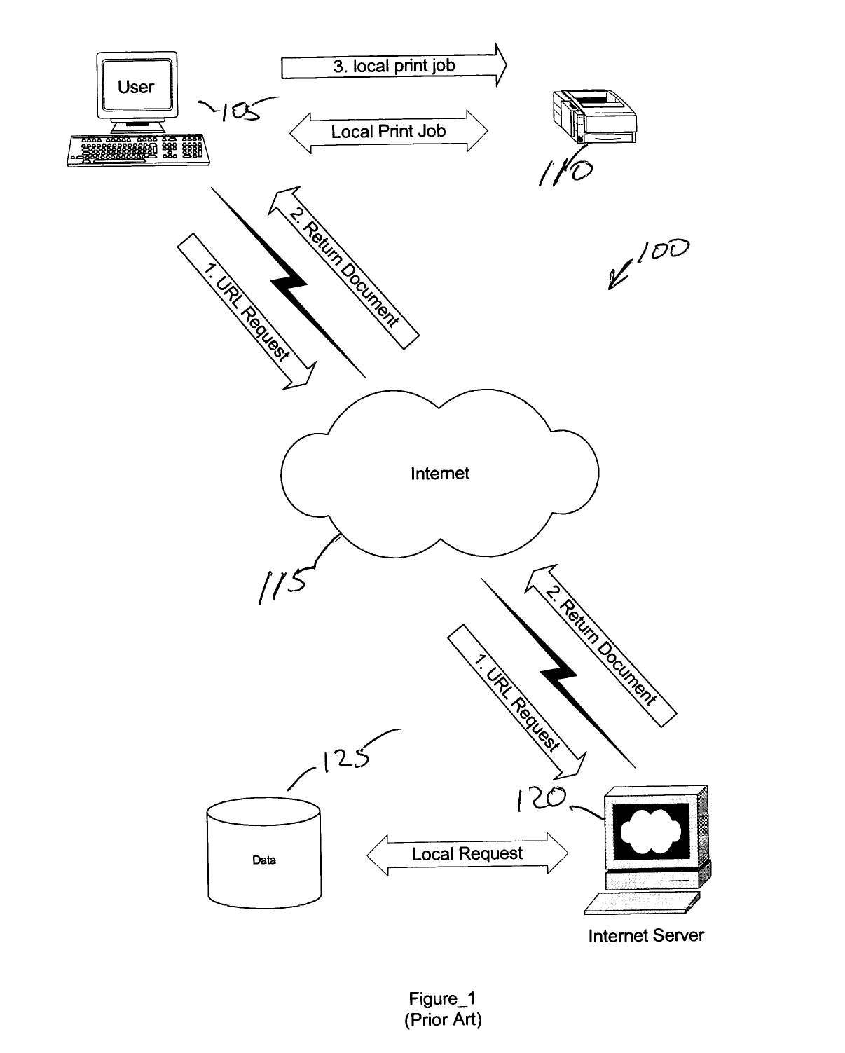

System 200 is preferable to system 100 shown in FIG. 1 because (1) the connection speeds/bandwidths between Server 215 and Print Server 225 are typically much greater than the connection speed/bandwidth between device 205 and Server 215; (2) document generator 230 will typically have superior document generation and finishing options as compared to local printer 110; (3) the user is able to quickly, easily and unambiguously associate the desired remote resource and the desired document generation and finishing options; and (4) of interface speed—the user does not have to wait to upload the resource before the remote processing may be configured as the configuration may be independent of the acquisition of the resource at the print server.

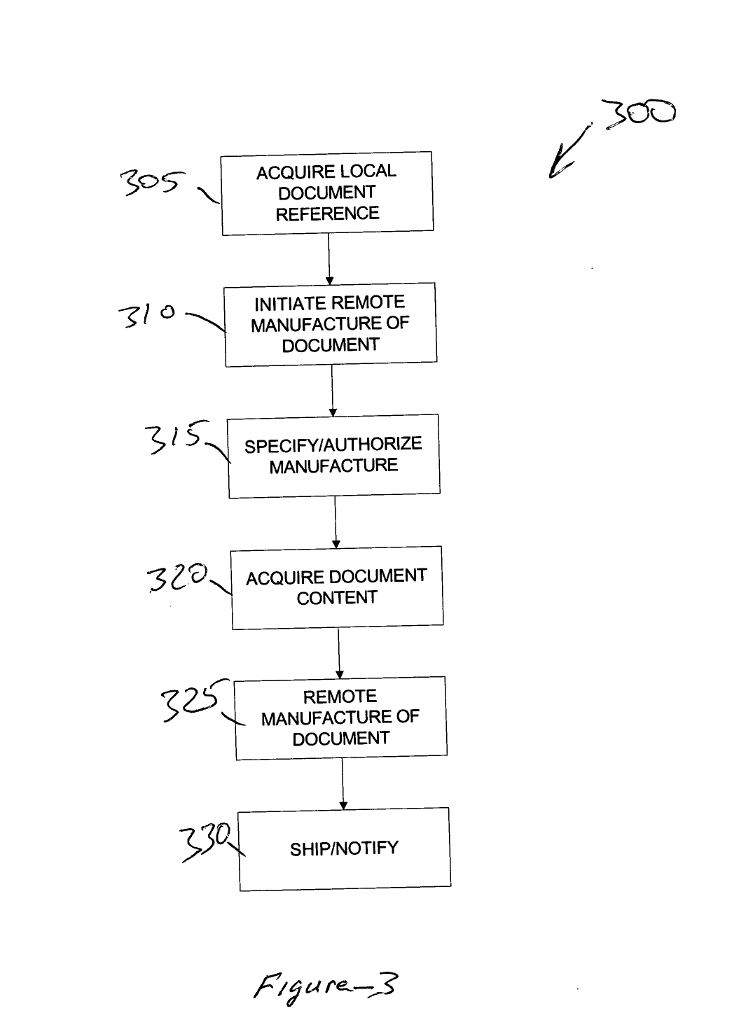

FIG. 3 is an overview flow diagram for a preferred remote resource process 300. Process 300 begins with acquiring a local document reference at step 305. Step 305 is preferably implemented by device 205 shown in FIG. 2 when the user “surfs the Internet” or otherwise navigates to a desired URL of a remote network resource. Device 205 will have one or more processes (e.g., applications) that permit the user to access the remote network resource to assess the resource's suitability for the user's anticipated use of the resource.

The preferred embodiment is implemented using the Portable Data Format (PDF) for the remote network resources, and a PDF application/browser/viewer such as Adobe Acrobat/Adobe Acrobat Viewer/Adobe Acrobat plug-in for Internet browsers. These processes permit a user to view a content of a PDF resource to verify that it is the desired content.

Next, step 310, process 300 initiates remote manufacture of document 235. This initiation includes communicating the identifier for the remote resource to print server 225, and in some cases, communicating locally derived document parameters.

After step 310, process 300 specifies/authorizes manufacture at step 315. Step 315 may include any number of sub-steps, such as specifying printing and finishing requirements specifications, pricing estimates, credit checks, document validity checks, or other implementation details related to the requirements for manufacture.

After specification/authorization, process 300 performs step 320 to acquire a copy of the resource content on print server 225. Server 225 uses the URL and the specification of a cover and other finishing/formatting selections to retrieve and generate the specified content. In the preferred embodiment, server 225 generates one or more temporary PDF files that contain the desired content, properly sized and formatted, of the cover and body. Server 225 may access several sites to acquire all the proper content, and may include preprocessing, processing and post-processing of the resource, resource content and/or local data.

Thereafter, process 300 remotely manufactures document 235 at step 325 when server 225 sends the temporary PDF file(s) to document generator 230. After step 325 manufactures the specified number of documents (including finishing/covers/binding), process 300 (step 330) ships the documents notifies the user that the document(s) has/have been manufactured and shipped. The preferred embodiment centrally manufactures documents and ships them when ready. However, in some implementations, it may be desirable to have several geographically distributed manufacturing centers where documents are rear manufactured and a user may elect to physically retrieve them after being notified of completion, or ship them from local centers to improve delivery times. In some geographic locations, documents may be messengered or couriered to the user for rapid, same-day document availability.

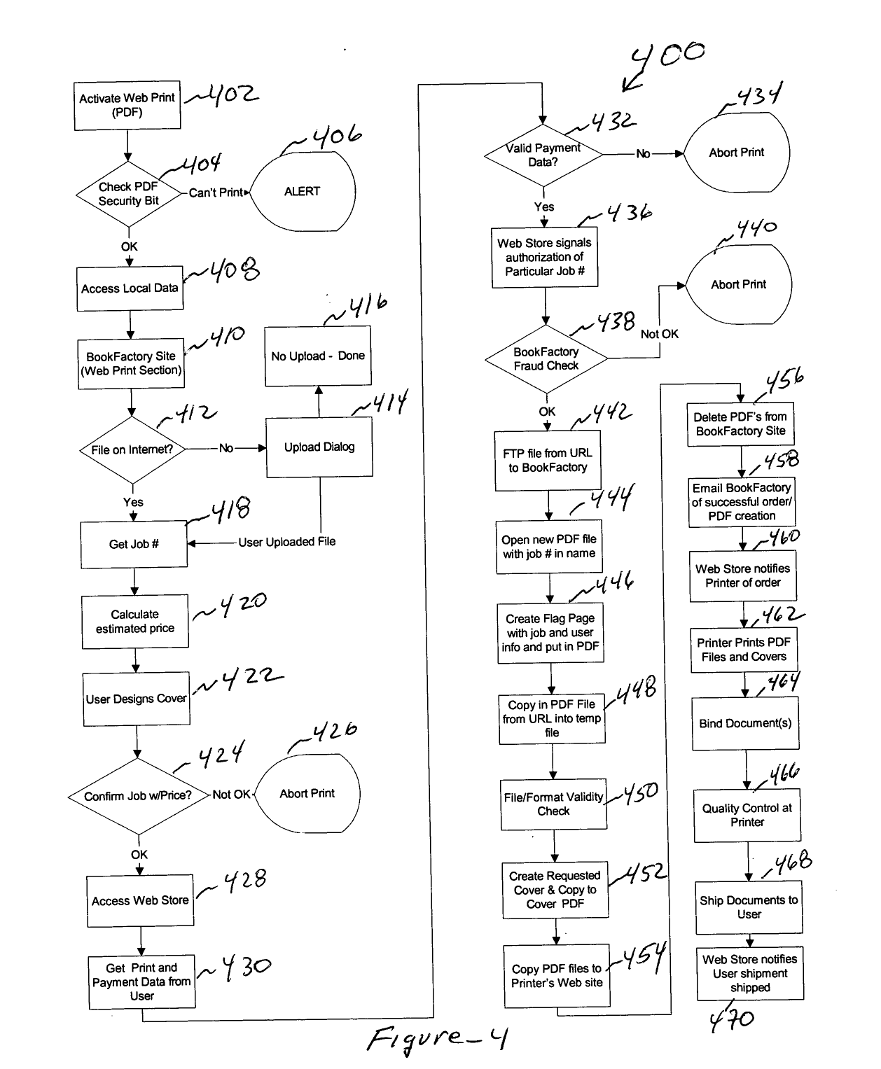

FIG. 4 is a detailed flow diagram for a preferred remote resource printing processing 400, including step 402 through step 470. Process 400 begins with step 402 activating a preferred web print of a PDF document when a user “clicks” or otherwise activates a processing trigger of a local process that has accessed a desired remote resource. Step 404 makes a local check of the document to determine whether a “DO NOT PRINT” security bit has been set for the resource. In the event that it has been set, process 400 alerts the user that the document will not be printed at step 406 and aborts further processing.

When the resource rights management feature does not inhibit further processing, process 400 completes step 408 to access local data from the local process. Step 408 may gather user data, the URL, page count data, or other information locally available as the local data. The local data may be used for subsequent checks/validations during process 400, and to speed the estimation and configuration steps.

Next, step 410, the local data is communicated to the processing web site. In the preferred embodiment, there is a special URL established on a special web site for handling requests from Adobe Acrobat applications, viewers, and plug-ins. Other local processes may require different processing and would get sent to a different section or sites adapted to process that resource type.

Step 412 tests whether the URL in the local data refers to a location for the resource that is accessible by the special web site. When the location is not accessible, step 414 initiates an upload, which could be performed automatically or after presenting an upload dialog screen to the user. When the user does not upload the resource, process 400 terminates further processing at step 416.

When the user uploads the resource or when the resource was available at an accessible location, process 400 executes step 418 to obtain a job number for the requested manufacture. Process 400, step 420, calculates an estimated price for the manufacture based upon the local data, preset criteria from the user, and/or after obtaining some preliminary information from the user as to quantity and print options. Step 420 is performed very quickly as the website does not need to access and review the actual content of the resource. The estimation is based upon the local data.

Process 400 provides at step 422 some options for cover design by the user. When any cover design options have been selected, step 424 next requests confirmation from the user that the user wants to proceed with the particular job number. If the user elects not to proceed, process 400 may abort manufacture at step 426, or process 400 may offer to permit the user to return to an earlier step to select different options.

When the user confirms the job with the particular options at the estimated price, process 400 accesses and directs the job number and the user to a web store (e.g., an Oracle-implemented web store or the like) for further processing of order payment, option selection, and document delivery option(s).

Through the web store, step 430 obtains print and payment data from the user. This data includes the number of copies, which pages are black & white and which are color, what type of binding is desired, whether the user desired two sided printing, or multiple pages per sheet of the final document, shipping information, name, address, and credit card/payment information.

Next, step 432 tests whether the payment information is valid. When the information is invalid, process 400 either notifies the user and either aborts or offers the user a chance to provide valid information (step 434). When no valid information is provided, step 434 notifies the special web site that the particular job number associated with the invalid payment information is not authorized for manufacture.

When the test at step 432 indicates that the information is valid, process 400 executes step 436 wherein the web store notifies the special web site of the valid order with job number and shipping information. In the preferred embodiment at step 438, process 400 includes an additional fraud check at the special web site to determine whether there are problems with the job or other concern exists. When the test at step 438 indicates that a problem exists, step 440 aborts the print process and notifies the user.

When the test at step 438 indicates valid payment data, process 400 performs step 442 to retrieve the target resource to the special web site FTP storage location. Next step 444 opens a new PDF file named using the job number. Step 446 next creates a flag page with job number and user/option information and inserts the flag page into the temporary PDF created at step 444. The PDF content from the network resource is copied into the temporary PDF file (step 448) and step 450 next checks paper/page size, page count, and other tests. When possible, the content of the individual resource pages are resized to fit onto the selected paper type.

Step 452 next creates the covers for the documents as specified by the user and copies the cover(s) into a cover PDF file. After the PDF files are created, the preferred embodiments transmits (step 454) the temporary PDF files to a web address for the printer identified for manufacturing the documents and deletes (step 456) these temporary PDF files from the special web site. The special web site is then notified (step 458) of the successful order/PDF creation, and then the printer is notified of the valid order (step 460).

Step 462 through step 468 has the printer manufacture and ship the document, aided by the flag page in the PDF files: step 462 prints the PDF files (content and covers); step 464 binds the document; step 466 is a quality control for the printer to double check the order; and step 468 is the shipment/delivery of the document(s) as specified by the user. Process 400 concludes at step 470 when the web store notifies the user that the order has shipped.

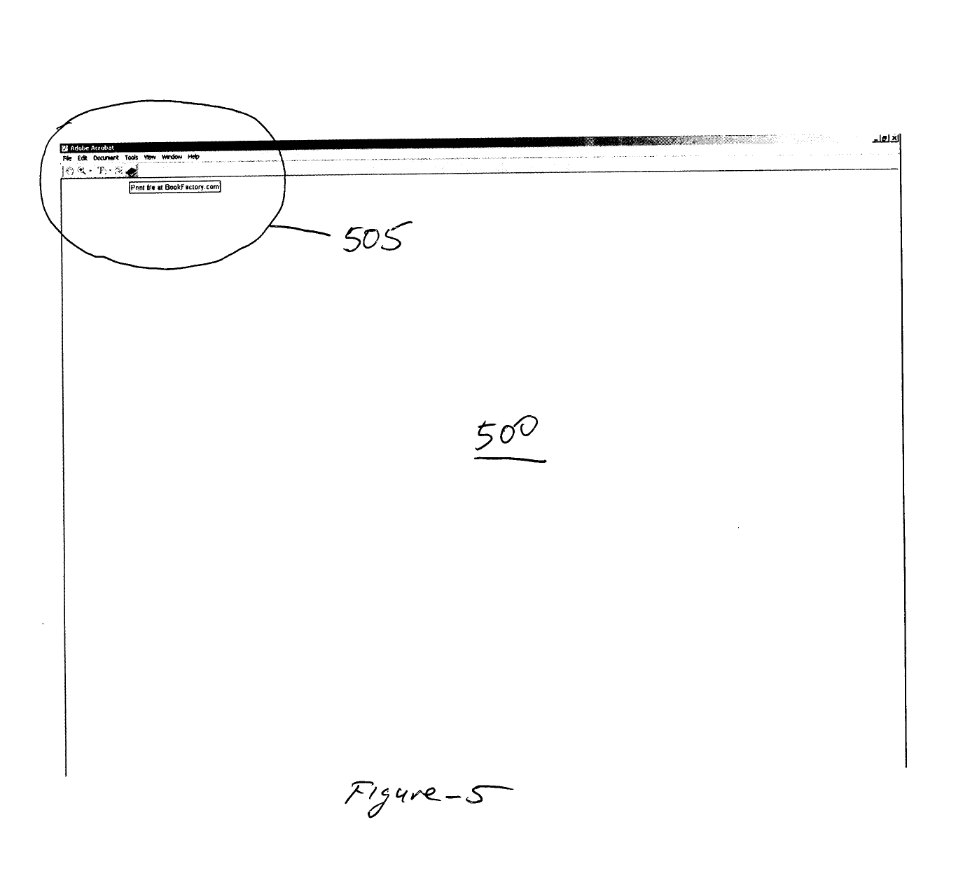

FIG. 5 is a screenshot of a process 500 on a local computing system for reviewing network resources. The process is preferably an Adobe Acrobat application that permits document review, either as a stand-alone application (e.g., Acrobat Reader) or as a plug-in for an Internet Browser (e.g., Acrobat Reader plug-in for Microsoft Internet Explorer). A portion 505 of the process menu/toolbar is emphasized to show the placement of a trigger icon for initiating web printing. (This is the trigger that when “clicked on” initiates process 400 shown in FIG. 4 using the current URL in the viewer.

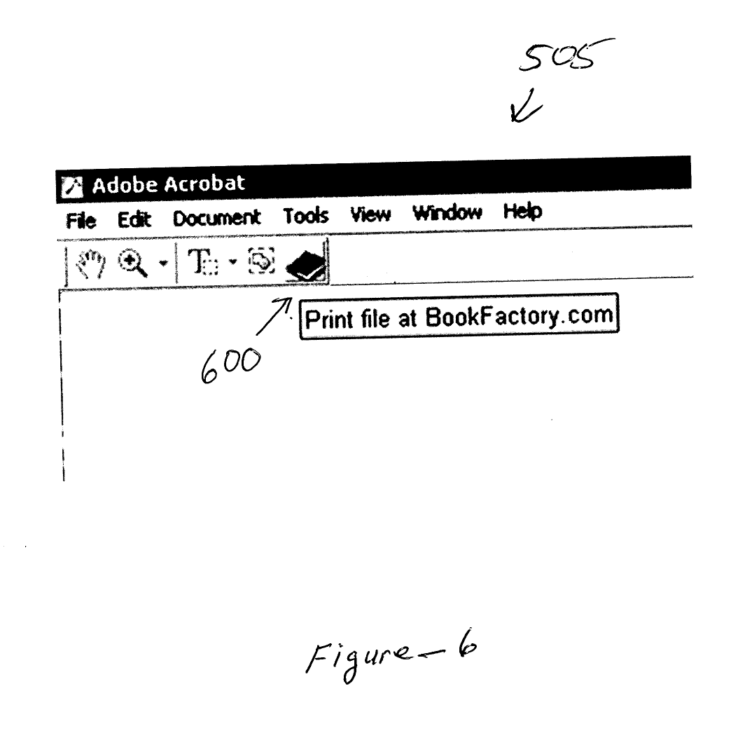

FIG. 6 is portion 505 of the screenshot shown in FIG. 5 illustrating a remote processing trigger 600 incorporated into a control structure of process 500. Trigger 600 initiates the remote printing using the file accessed by process 500. The “Print file at Bookfactory.com” text is the tool tip help that is displayed to aid the user when moving a cursor over trigger 600 prior to activating it. Other forms and manner of initiating process 400 are also contemplated by the present invention, such as menu options, entries into the printer list of the local computer and other well-known ways of initiating a local process on a computing system.

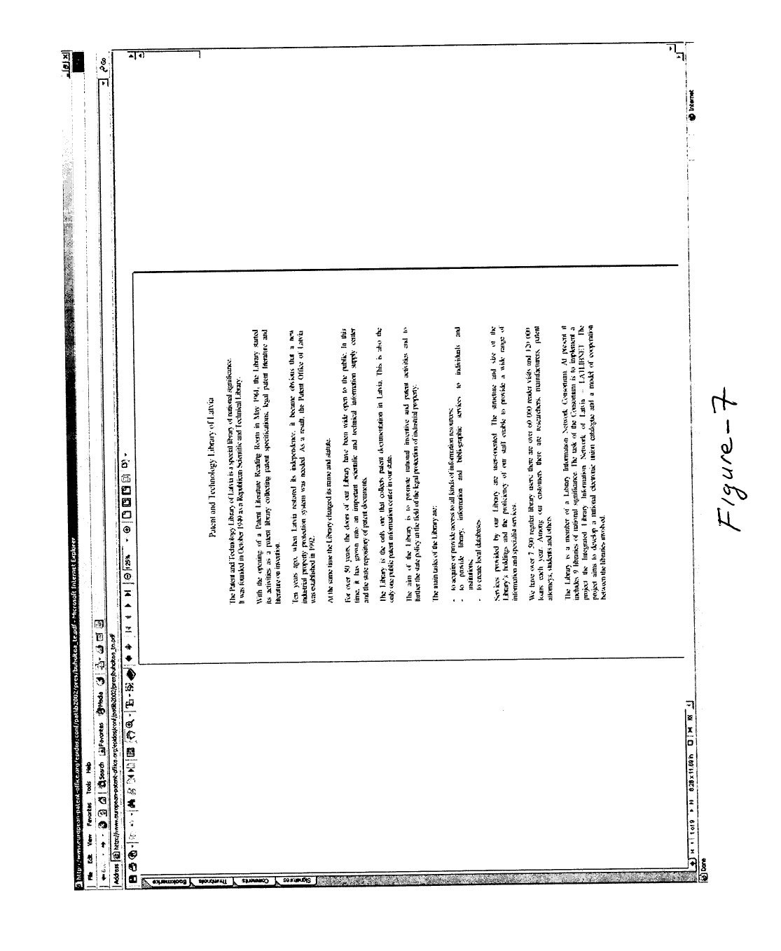

FIG. 7 is a screenshot of process 500 shown in FIG. 5 after accessing a remote network resource:
http://www.european-patent-office.org/epidos/conf/patlib2000/pres/buholtea_te.pdf. As illustrated, process 500 has a local cache of the resource content that is viewed by operating navigation controls. Additionally, process 500 has some local information about the resource, including the resource URL (displayed in the Address line), the total number of pages of the resource, various security and copy management features set for the resource, as well as other information.

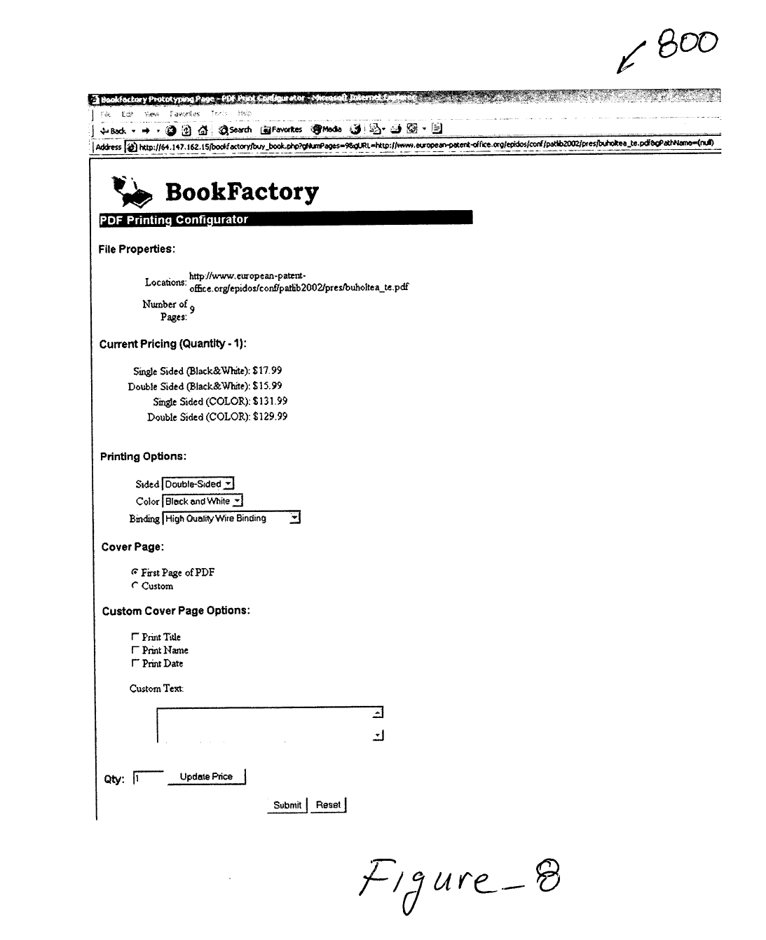

FIG. 8 through FIG. 10 are a series of screenshots illustrating the setup of the remote processing of the network resource illustrated in FIG. 7 after actuation of remote processing trigger 600 shown in FIG. 6.

FIG. 8 is a screenshot of a PDF printing configurator 800 screen that appears after activating trigger 600. Configurator 800 presents the user with results of a process that uses the local data to estimate the manufacturing cost for the user prior to initiating the checkout/payment/validation procedures of the web store. Configurator 800 may either be executed locally using current pricing information for available options, or executed remotely by the special web site after receiving the local information. Configurator 800 confirms the resource URL and identifies the total number of pages in the document. Initially, current pricing is for a manufacture quantity of one (1) unit, with common color/paper duplex options individually priced so the user is able to quickly access the potential cost prior to actually initiating the web store process. (Configurator 800 of the preferred embodiment uses only the local data to estimate and configure, and does not directly access the resource to be processed for the estimate.)

Configurator 800 also presents some controls to permit the user to specify the particular options the user desires, having a general knowledge of the potential cost of the various options prior to selecting them. Options selectable in the preferred embodiment include whether to print single-sided or double-sided; whether to print in color or black and white; and what type of binding is to be used. Some of the options, such as binding options, may increase the delivery time. For example a sewn, hard cover binding option will typically add additional time due to the manufacturing time involved. Other options such as high quality wire binding will not typically affect the manufacturing time.

Configurator 800 also permits the user to specify cover page option. The preferred embodiment defaults to use of the first page of the resources content as the cover page, but the user may elect to produce a custom cover page. Configurator 800, as an example, permits the user to print user-entered data for a title, a name, a date and/or a custom text message as the cover. Other implementations may provide greater or fewer options for the cover page.

Configurator 800 also allows the user to change the desired quantity of documents to be manufactured. Configurator 800 permits the user to update all the displayed prices based upon selection of a new quantity or other option.

Once the user has configured the user-selectable manufacture options, and the estimated prices for the desired configuration are presented, the user may either continue reconfiguring, reset the configurator to the default page, cancel the process, or submit the order to manufacturing. The user continues the manufacturing process by “clicking” the “submit button” of configurator 800.

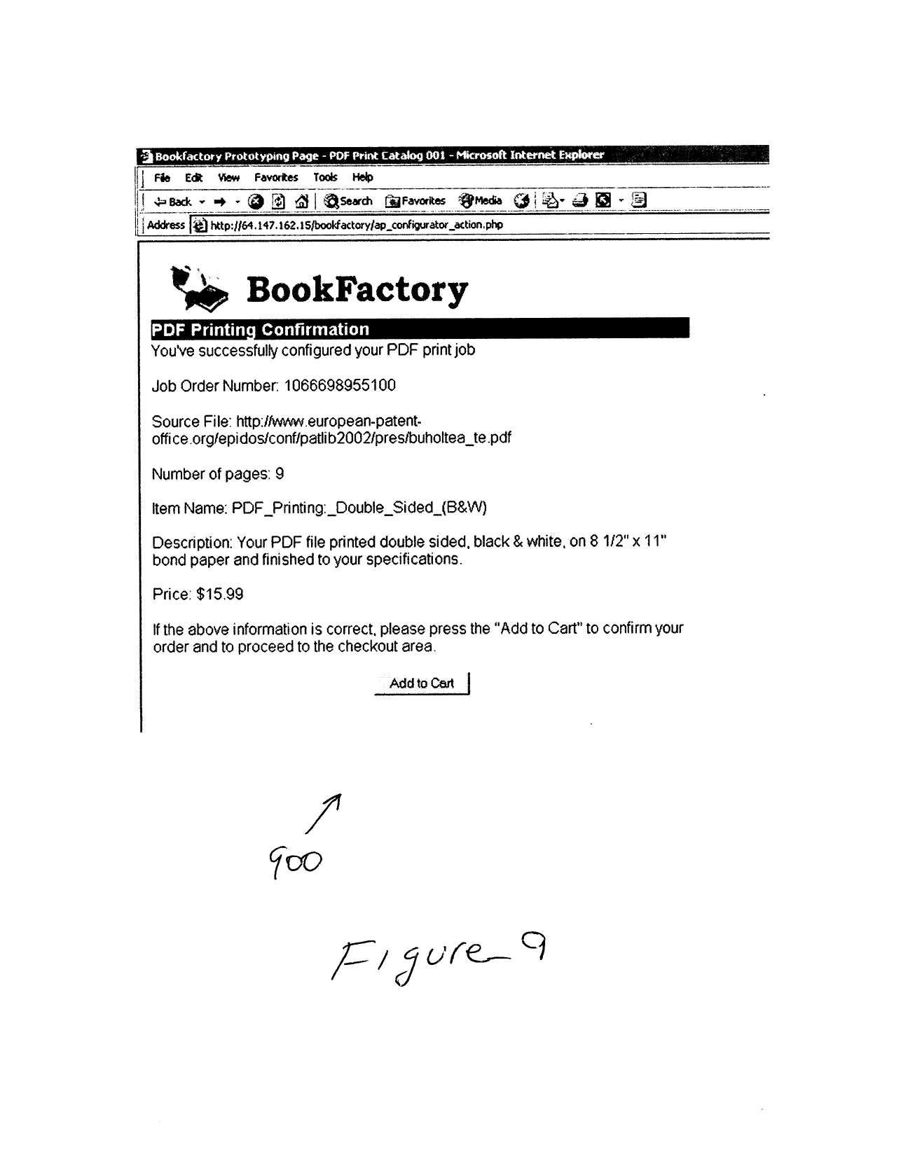

FIG. 9 is a screenshot of a PDF printing confirmation 900 screen previous to entering into a web store and after the submission of a manufacturing request using the submit button of configurator 800 shown in FIG. 8. Confirmation 900 confirms to the user successful configuration of the resource print job and provides the user with a job number for reference. Additionally, confirmation screen 900 presents the user selected options, size of the document and estimated price and requests that the user enter the web store if the information is acceptable. Confirmation 900 may also include some pre-manufacture validity checks to verify that the resource is a suitable resource for processing/manufacture. For example, it is not uncommon for electronic documents to include many extraneous page breaks, resulting in a document that could be hundreds or thousands of pages in length. Some checks on page count, for example, are made at periodic steps in the manufacturing process. Confirmation 900 includes an “Add to Cart” button to permit the user to enter the web store to enter payment and shipment information. Configurator 800 and/or confirmation 900 could also be incorporated into the web store in some implementations, when necessary or desirable.

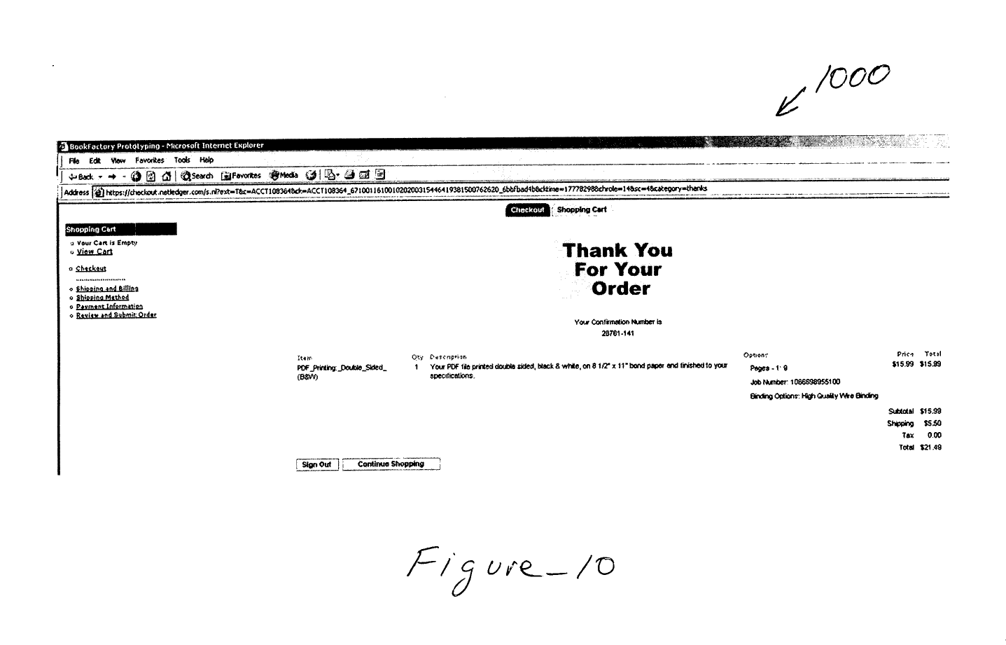

FIG. 10 is a screenshot 1000 of a confirmation at the conclusion of the web store process when payment and shipment information validation was successful. The web store notifies the user, the special web site, and the printer all of the authorization (pass/fail) for the job numbers initiated by configurator 800. There are many different web store/shopping cart solutions that may be used in the present invention.

The present invention is a simple solution that, in the preferred embodiment, adds remote printing to any process/application that locates/processes a remote network resource, such as for example Adobe Acrobat products/viewers/plug-ins, Internet browsers, and applications like Microsoft Office, Quark Express or AutoCAD. Simply clicking a button presented on a toolbar of the application initiates the configurator process for the user to choose desired remote processing options appropriate to the resource and implementation. In some implementations, users may establish default information for the configurator and store, and the manufacture process may permit “one-click” manufacture responsive to actuation of this button using all the default processing/manufacturing options, payment options and shipping instructions. Checks on pricing/page count are still performed, and preferably some confirmation screen will always appear prior to actually manufacturing any document.

As discussed above, in a simple implementation for web-based printing from a local computer, an application having this feature installed permits a user reviewing a document (remote or local) in an application (e.g., a web browser) to click on the trigger (e.g., control, icon, menu item, etc.) for remote printing (including print and ship, or print and bind, or other print/finish process). In response, a process on the local computer passes data on the file being viewed to a remote computer system that performs the processing appropriate to the implementation (e.g., printing).

From the server perspective, it is a remote FTP process with the print server receiving a resource identifier that initiates the server to automatically retrieve the file from an Internet server using the identifier. The server automatically retrieves the file and processes it, including formatting, resizing, printing, finishing, etc. In some cases the resource identifier may not be accessible by the server even though it is locally available. The configurator process is able to implement the upload feature to provide the remote printing/finishing/shipping advantages that are offered in the preferred embodiment. It is not necessary for the resource identifier to include an explicit document reference. In some cases the resource identifier is a library call with appropriate library identifier. The identifier may identify a particular document or identify a particular user and the library providing the document appropriate for the user.

The advantage of presenting an estimated printing cost and receiving confirmation in advance of physically retrieving the document at the remote print server to calculate the cost is that the user experience becomes a much faster process. For printing implementations, a main cost component is the number of pages and that is available from the local application prior to initiating the remote processing service.

A further advantage is that the user does not have to wait for the retrieval of the document by the remote print server prior to initiating and/or completing the order process. The order/payment information may be provided in advance or concurrently with acquiring the resource using the resource identification. This frees up the user's time and makes the interaction process much quicker.

While the above description was made detailing various processes performed on a local machine, a remote machine, a print server and/or a special web site, certain functions and processes may be implemented in different locations than those described above. Information may be gathered earlier or later by different entities in the manufacture process.

The preferred embodiment includes additional processing functions that may be pre-printing formatting processes. For example, some resources are created only with an online viewer option in mind, so that the individual pages in the document have different sizes and orientations, and some of the sizes of the resource pages do not have to conform to standard paper sizes like 8.5″×11″ or A4 paper sizes. The preferred embodiment is able to scale large pages to fit onto the selected paper size when one or more pages are too big. Additionally, for smaller sized images, the preprocessing may center the image or scale it to fit. Further options include addition of page numbers, page headers/footers, watermarks or other custom content to the desired resource. The custom content may include addition of crop marks, color separation and trapping, and the addition of job information on the various pages.

Preprocessing in the preferred embodiment includes digital rights management checks when necessary or desirable. These checks include electronic checks, comparisons against a copyright clearing house, maintenance of a “do not print list” of links registered by copyright owners, or other system.

The temporary files created by the print server may be modified to automate the manufacture and to take advantage of available printer/finishing resources. For example, when a user desires a large quantity of documents, the temporary file may actually include multiple copies of the same document so an operator does not have to manually enter the desired quantity or other options. Multiple temporary files may be created and the manufacturing tasks performed in parallel on different printers to increase the response time of the manufacturing. The temporary files, in some alternate preferred embodiments, include printer control information added into headers of the temporary file (e.g., a temporary PDF file) that is not printed but is recognized as printer control codes. These printer control codes are another way of fully automating the document production system to minimize manual operator intervention in the manufacturing process.

The pre-processing of the preferred embodiment may also include auto-translation of a document content prior to printing. A translator is used at the print server and preprocesses the text. Translation may be limited to resources in other than image format to produce acceptable translation quality. As discussed above, the preprocessor may also print multiple resource pages on each individual page of the manufactured document. This produces a smaller sized book with 2 or 4 resource pages per document page. The resolution of the printers used can make this feasible when it may not be for a local user's printer. Other preprocessing options include file creation options that are transparent to the user but result in a lower cost due to efficient printing. For example, rather than printing on 8.5″×11″ paper, it may be advantageous cost-wise for the printing process to use 11″×17″ paper and print two resource pages on each sheet and then cut the paper as is well-known. Such printing cost savings may be passed on to the user. This is an example of a cost reduction solution that would otherwise be unavailable to most local users with their local printers.

Some resources are available in a format that permits additional preprocessing, such as when the text stream of the resource is available rather than when it exists as an image format. When the text stream is accessible, additional formatting options are available, such as increasing the font size to improve readability or decreasing font size to reduce the size of the manufactured document.

It is understood that while the preferred embodiment uses PDF, other document formats are available for use in other implementations. These other formats include RTF (rich text format), and alternatives to PDF, some of which are proprietary formats. The output documents could be special purpose documents such as blueprints or technical drawing/graphing programs.

An alternate preferred embodiment is a print link feature that is made available to web site operators. The web site operator may make certain of its links available for remote printing by users of its web site. Rather than having the user access and cache a local copy of the document, the user is permitted to click on a link for remote printing and the web site operator causes the link and/or the resource to be sent to the configurator on the user's behalf. The user is then able to use the configurator as discussed above to select quantity, finishing, shipment and payment information. This web site may pass the link only, the link and local data (like page count), user account information (including shipping/charge information) or any combination. Missing information is completed by the user or the web site.

For example, a web site could send:

http://www.printrocket.com/bookfactory/buy_book.php?gNumPages=410&gURL=h

ttp://developer.apple.com/documentation/mac/pdf/HIGuidelines.pdf&gPathName=(null)

without the web site having to know any details about the processing/manufacturing process. The manufacturing process handles all details of manufacturing and the resulting document may even be a hard bound book. Web sites are enabled to provide, in a simple fashion, hard copies of their documents. By providing a suitable resource identifier to the print server, document manufacturing is seamlessly enabled. Since the web site maintains the document and the link, the web site is able to ensure that a user always gets the current version.

A print link option also provides a way for a user or a web site to dynamically create a temporary file customized by the user. This temporary file may include several documents, one or more search results, a record of their browsing session, or other collection of material. Thereafter the link to this temporary file is used by the configurator to begin the manufacturing process.

The print link option not only enables convenience to the web site and the user, this option provides an option for revenue sharing or print-on-demand. The configurator/web store screens are able to be customized for particular referring sites so the user will not necessarily tell that the printing is not performed by the original web site, and by including account information in the print link, the referring web site can be paid a portion of the revenue derived from the document manufacture. Authors are able to use print link to provide a quick and easy print-on-demand service with minimal effort. The print server includes a protocol to define covers appropriate for such documents, with the author/web site defining how a cover should be printed. The print link option may include the cover control option in the link to set a cover content ftp location and formatting/printing options. In some of these options, there is no document review/local cache option available or necessary. It is simply a link and print operation.

The potential for royalty sharing exists among the various entities involved in the content creation, linking, preprocessing, manufacturing, and post processing activities, depending upon the preferences and responsibilities of the participants.

As also discussed above, the processing at the print server includes various tests for valid resources before and during the generation of the temporary files that will actually be manufactured. Users, and other entities having a need to know, are notified when there are issues with a file, Such as 1,000,000 pages, or large runs of blank/all black pages or other infirmities.

The preferred embodiment is most preferably implemented to minimize operator input so the document manufacture is completely automated. The communication from the print servers to the document generators permits documents to be added directly into the print queues of the document generators. Quantities are controlled via the number of temporary files, the number of documents placed inside each temporary file, and/or via the printer control codes in the headers of the temporary files. The document generators feeds printouts into finishers that in turn output into machines that box/envelope the documents and apply the shipment address to the outside via a label or inkj et from the information on the flag page or in the header information. The manufactured, boxed, and addressed documents are then routed to a shipping bin or chute. Minimal human intervention is required for many documents.

When manual intervention is necessary, the preprocessing and document manufacturing is able to improve efficiency of the manual operation steps. Color coded flag pages and easy to read instructions are provided to minimize errors in manufacturing. This information is provided in the headers of the temporary files, or stored on the flag page.

As discussed above, the print server distributes print jobs to one or more document generators. The same operator as the print server operator may own/control the document generators, or they could be operated by various commercial printing houses, or a network of printers distributed in strategic locations. A heuristic determines which generator receives which manufacture jobs. The decision may be based upon geography (closest to shipment location), cost, capability (color, finishing, binding, etc.), or round robin. For example, the print servers could identify a particular Kinko's copy center for document generation. In some implementations, the user may be able to select the desired manufacturing center, such as for example, when the user has preferential pricing or is convenient to a user's location.

Commercial printers may implement the preferred embodiment as a service to their clients. Appropriate software is provided that directs the print job to a specific printing company when the trigger is actuated. Some commercial printers may prefer to have the print server preprocessing/processing performed by a third party and have all the temporary files sent to them.

The preferred embodiment refers to local printing and remote resource manufacturing. In some implementations, the remote processing may be performed on a remote print server available to local devices on a local area network, such as for manufacture of documents inside a company.

One of the preferred implementations of the present invention is as a routine in an operating system made up of programming steps or instructions resident in a memory of a computing system shown in FIG. 2, during computer operations. Until required by the computer system, the program instructions may be stored in another readable medium, e.g. in a disk drive, or in a removable memory, such as an optical disk for use in a CD ROM computer input or in a floppy disk for use in a floppy disk drive computer input. Further, the program instructions may be stored in the memory of another computer prior to use in the system of the present invention and transmitted over a LAN or a WAN, such as the Internet, when required by the user of the present invention. One skilled in the art should appreciate that the processes controlling the present invention are capable of being distributed in the form of computer readable media in a variety of forms.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

1. A system, comprising:
a user network device accessing a remote network resource;
a network repository for storing said remote network resource at a remote location other than a local location of said user network device; and
a network processor for receiving an identifier for said remote network resource from said user network device, said network processor operating in response to a processing control from said user network device on said remote network resource at a processing location other than said local location upon receipt of said identifier for said remote network resource from said user network device.

2. The system of claim 1 wherein said user network device is a personal computer and said remote network resource is a document, wherein said network repository includes a server having a memory storing said document and wherein said network processor includes a computing system communicated to a printer, wherein said identifier is a Uniform Resource Locator (URL) for said document stored in said repository and said computing system uses said URL to access and print said document on said printer.

3. A method for processing a network resource, the method comprising:
sending an identifier for a remote network resource to a remote location from a local location;
accessing said remote network resource at said remote location using said identifier; and
processing said remote network resource at said remote location.

4. The method of claim 3 wherein said processing step includes printing at least a portion of said remote network resource at said remote location.

5. The method of claim 3 wherein said remote network resource is a document, wherein said identifier is a Uniform Resource Locator (URL), wherein said accessing step retrieves said document using said URL from a network server storing said document, and wherein said processing step includes printing.

6. A network processing system, comprising:
a user network device for locating a remote network resource, said user network device communicated to a network at a first connection speed;
a network repository, communicated to said network, for storing said remote network resource at a remote location other than a local location of said user network device; and
a network processing system, communicated to said network at a second connection speed greater than said first connection speed, for receiving an identifier for said remote network resource from said user network device, said network processing system retrieving said remote network resource from said network repository at said second connection speed and performing a processing task on said remote network resource on behalf of said user network device.

7. A system, comprising:
a local process executable on a local network device for locating a remote network resource, said process providing a user actuable control for a remote network resource of a particular type wherein said user actuable control communicates a resource identifier to a remote network device upon activation;
a remote memory location for storing said remote network resource accessible using said resource identifier; and
a remote process executable on said remote network device for receiving said resource identifier, accessing said remote network resource from said remote memory location, and processing said remote network resource.

8. The system of claim 7 wherein said local process is a browser, said particular type of data is a document, said resource identifier is a Uniform Resource Locator (URL) and said remote process includes a printing function.

9. The system of claim 7 wherein said user actuable control communicates user account information.

10. The system of claim 7 wherein said user actuable control communicates resource parameters to said remote network device.

11. The system of claim 8 wherein said document is formatted using a Portable Document Format (PDF).

12. The system of claim 11 wherein said user actuable control communicates a document parameter to said remote process.

13. The system of claim 12 wherein said document parameter includes a total number of pages.

14. A system, comprising:
a local process executable on a local network device for locating a remote network resource, said process providing a user actuable control for a remote network resource of a particular type wherein said user actuable control communicates a resource identifier to a remote network device upon activation;
a remote memory location for storing said remote network resource accessible using said resource identifier; and
a remote process executable on said remote network device for receiving said resource identifier, accessing said remote network resource from said remote memory location, and processing said remote network resource,
wherein said user actuable control communicates a resource parameter to said remote process prior to remote processing, with said resource parameter associated with a remote processing charge for said processing.

15. The system of claim 14 wherein said remote resource is a document, said document parameter is a number of pages of said document, said processing includes printing at least said number of pages, and said remote processing charge includes a printing charge for said processing.

16. A pricing method, the method comprising:
accessing a remote network resource at a local location;
sending an identifier and one or more locally determined processing parameters for said remote network resource from said local location to a remote location; and
determining a processing price for said remote network resource at said remote location using said one or more locally determined processing parameters.

17. A method for network printing, the method comprising:
accessing one or more network documents stored in a remote memory location;
sending one or more identifiers, at least one for each of said one or more network documents, to a remote process that is associated with a printing system;
retrieving said one or more network documents by said remote process from said remote memory location using said one or more identifiers; and
printing said one or more network documents using said printing system.

18. The method of claim 17 wherein said sending step includes sending account information to said remote process.

19. The method of claim 17 wherein said sending step includes sending printing and shipping instructions to said remote process.

20. The method of claim 17 wherein said sending step includes sending document parameter information to said remote process.

21. A network resource processing method, the method comprising:
opening and displaying a remote network resource on a local network device using a local process of said local network device, said remote network resource stored in a remote memory;
enabling a remote processing control associated with said local process for communicating an identifier of said remote network resource to a remote process appropriate for said remote network resource on a remote network device;
accessing said remote network resource from said remote memory by said remote process using said identifier received from said local process; and
processing said remote network resource by said remote process.

22. The network resource processing method of claim 21 wherein said remote network resource is a document and said remote process is associated with a printing function and wherein said processing step includes printing said document.

23. The network resource processing method of claim 22 wherein said local process is a browser.

24. The network resource processing method of claim 22 wherein said local process is a word processor.

25. The network resource processing method of claim 22 wherein said local process is a document formatting application.

26. The network resource processing method of claim 25 wherein said document formatting application is Adobe® Acrobat® software.

27. The network resource processing method of claim 22 wherein said local process is a computer-aided design (CAD) application.

28. The network resource processing method of claim 27 wherein said CAD application is AUTOCAD® software.

29. The network resource processing method of claim 21 wherein said processing step includes receiving said remote network resource at a commercial shop specific for said remote network resource and producing a commercially produced publication of said remote network resource at said commercial shop.

30. The network resource processing method of claim 28 wherein said remote network resource is a document, wherein said commercial shop is a print shop, and wherein said commercially produced publication includes a bound document produced from a commercial printer.

31. A system, comprising:
a local process executable on a local network device for locating a remote network resource; and
a trigger, coupled to said local process, for initiating a communication of a resource identifier of said remote network resource to a remote network device upon activation and wherein said remote network device is responsive to said resource identifier to obtain said remote network resource using said resource identifier.

32. The system of claim 31 wherein said trigger initiates a communication of user account information to the remote network device.

33. The system of claim 31 wherein said trigger initiates a communication of a processing parameter of said remote network resource used by said remote network access.

34. The system of claim 31 wherein said remote network resource is a document in a portable document format (PDF) and said remote network resource is communicated to a printing system.

35. The system of claim 34 wherein said trigger initiates a communication of a page count for said document.

36. The system of claim 34 wherein said trigger initiates a remote document manufacture process.

37. The system of claim 36 wherein said remote document manufacture process accepts one or more user document manufacture control parameters.

38. The system of claim 37 wherein said one or more user document manufacture control parameters includes one of a print quantity, a color option, a binding option and a delivery option.

39. The system of claim 31 wherein said local process is a resource processing application.

40. The system of claim 39 wherein said resource processing application is an Adobe Acrobat document application.

41. The system of claim 39 wherein said resource processing application is an Internet browsing application.

42. The system of claim 41 wherein said resource processing application is an Adobe Acrobat viewer browser plug-in.

43. A system, comprising:
a network repository for storing a resource, said network repository communicating said resource to a local process executing on a local network device coupled to said network repository wherein said network repository provides said resource to a remote network device in response to a request from said remote network device initiated from receipt of an identifier for said resource by said remote network device from said local network device.

44. A document production system, comprising:
a local network device accessing a network resource for document production, said network resource having an identifier and a number of printed pages and said local network device specifying a document production control;
a remote network device for receiving said identifier and said number of printed pages from said local network device wherein said remote network device retrieves said network resource using said identifier, authorizes document production using said number of pages and produces a document from said network resource responsive to said document production control.

45. A document production system, comprising:
a network communication system for receiving a document process request from a network device wherein said document process request includes an identifier for a remote network resource having a desired content;
an authorization system, coupled to said network communication system, for receiving from said network device a document production specification and a document production funding source; and
a printing system, coupled to said communication system and to said authorization controller, for producing a printed document having said desired content and conforming to said document production specification when authorized by said authorization system.

46. The document production system of claim 45 wherein said remote network resource is not included in said document process request.

47. A network printing method, the method comprising:
receiving, by an authorization engine, an identifier for a network resource and a printing authorization control datum from a local network device wherein said network resource includes a preestablished page content and a content format for each of a plurality of pages of said network resource;
performing a preliminary threshold authorization check by said authorization engine using said printing authorization control datum;
estimating, in response to said preliminary threshold authorization check meeting a predetermined criterion, a fee for commercially printing said network resource;
receiving authorization from said local network device to print a network publication including said preestablished page content having said content format using a predetermined printing option;
accessing said network resource using said identifier over a network coupled to said local network device, said identifier including a URL to said network resource wherein said URL refers to a memory location other than said local network device and wherein said memory location is accessible by a remote network device coupled to said authorization engine;
printing said network publication using said predetermined printing option at a commercial printer; and
transferring said network publication to a location specified by said local network device.

48. A computer program product comprising a computer readable medium carrying program instructions for initiating remote processing of a resource when executed using a computing system, the executed program instructions executing a method, the method comprising:
a) identifying a resource identifier for the resource from a local process of the computing system; and
b) communicating the resource identifier to a remote process to initiate a remote processing of the resource.

49. The computer program product of claim 48 wherein said local process is a resource processing application.

50. The computer program product of claim 49 wherein said resource processing application is an Adobe Acrobat application.

51. The computer program product of claim 49 wherein said resource processing application is an Adobe Acrobat viewer plug-in for an Internet browsing application.

52. A computer program product comprising a computer readable medium carrying program instructions for processing of a resource when executed using a computing system, the executed program instructions executing a method, the method comprising:
a) receiving a resource identifier for the resource from a process on a second computing system;
b) retrieving, responsive to receipt of said resource identifier, said resource from a third computing system using the resource identifier;
c) initiating a processing authorization process; and
d) processing, responsive to an authorization from said processing authorization process, said resource.

53. The computer program product of claim 52 wherein said receiving step a) further includes receiving resource parameter data of the resource from the second computer system.

54. The computer program product of claim 52 wherein said processing authorization process includes a payment receipt process.

55. The computer program product of claim 52 wherein said processing step d) includes a printing process.

56. A document production system, comprising:
a local network device for locating and specifying a network resource for document production, said network resource having an identifier and a number of printed pages and said local network device specifying a document production control; and
a remote network device for receiving said identifier and said number of printed pages from said local network device wherein said remote network device retrieves said network resource using said identifier, authorizes document production using said number of pages and produces a document from said network resource responsive to said document production control.

57. A document production system, comprising:
a network communication system for receiving a document process request from a network device wherein said document process request includes an identifier for a remote network resource having a desired content;
an authorization system, coupled to said network communication system, for receiving from said network device a document production specification and a document production funding source; and
a printing system, coupled to said communication system and to said authorization controller, for producing a printed document having said desired content and conforming to said document production specification when authorized by said authorization system.

58. The document production system of claim 57 wherein said remote network resource is not included in said document process request.

59. A network printing method, the method comprising:
receiving, by an authorization engine, an identifier for a network resource and a printing authorization control datum from a local network device wherein said network resource includes a preestablished page content and a content format for each of a plurality of pages of said network resource;
performing a preliminary threshold authorization check by said authorization engine using said printing authorization control datum;
estimating, in response to said preliminary threshold authorization check meeting a predetermined criterion, a fee for commercially printing said network resource;
receiving authorization from said local network print device to print a network publication including said preestablished page content having said content format using a predetermined printing option;
accessing said network resource using said identifier over a network coupled to said local network device, said identifier including a URL to said network resource wherein said URL refers to a memory location other than said local network device and wherein said memory location is accessible by a remote network device coupled to said authorization engine;
printing said network publication using said predetermined printing option at a commercial printer; and
transferring said network publication to a location specified by said local network device.

60. A resource processing system for processing a network resource from a local network device, comprising:
a first remote process for receiving local data for the network resource to produce a process configuration for the network resource; and
a second remote process for receiving an identifier for the network resource and processing the network resource responsive to said process configuration.

61. A processing method for a network resource, the method comprising:
receiving local data for the network resource at a configuration process to produce a process configuration for the network resource;
receiving an identifier for the network resource and the process configuration at a production process; and
processing the network resource responsive to the process configuration.

62. A computer program product comprising a computer readable medium carrying program instructions for processing a network resource when executed using a computing system, the executed program instructions executing a method, the method comprising:
receiving local data for the network resource at a configuration process to produce a process configuration for the network resource;
receiving an identifier for the network resource and the process configuration at a production process; and
processing the network resource responsive to the process configuration.

63. A resource processing system for initiating processing of a network resource from a local network device through an intermediary network process, comprising:
a local process of the local network device for specifying the network resource to the intermediary network process;
a first remote process for receiving local data for the network resource to produce a process configuration for the network resource; and
a second remote process for receiving an identifier for the network resource and processing the network resource responsive to said process configuration.

64. The system of claim 63 wherein said local data is received from said local process.

65. The system of claim 64 wherein said local process is a resource accessing application.

66. The system of claim 65 wherein said application includes an Internet browsing process.

67. The system of claim 63 wherein said local data is received from the intermediary network process.

68. The system of claim 67 wherein the intermediary network process includes a web server on a remote network device.

69. A resource processing system for processing a network resource from a local network device, comprising:
a first remote process for receiving local data for the network resource from a resource accessing process of the local network device to produce a process configuration for the network resource; and
a second remote process for receiving an identifier for the network resource and processing the network resource responsive to said process configuration.

70. The system of claim 69 wherein said first remote process is a configurator process that estimates a processing cost solely from the local data.

71. The system of claim 69 wherein said second remote process produces one or more printer files from the network resource.

72. The system of claim 71 wherein said second remote process inserts printer control codes into one or more printer files.

73. The system of claim 71 wherein said second remote process implements a preprocess of at least a portion of a content of the network resource.

74. The system of claim 73 wherein said preprocess scales said portion.

75. The system of claim 73 wherein said preprocess modifies a font of said portion.

76. The system of claim 73 wherein said preprocess reduces a page count for the network resource.

77. The system of claim 76 wherein said preprocess combines content from at least two pages of the network resource onto a single page of one of said pages in said one or more printer files.

78. The system of claim 73 wherein said preprocess translates at least one word of the network resource from one language into a second language to produce a translation wherein said translation is substituted in a printer file for said at least one word.

79. The system of claim 73 wherein said preprocess juxtaposes content of portions of at least two pages of the network resource onto a single printer page in at least one of said printer files.

80. The system of claim 79 wherein said at least two pages of said network resource have a first height and a first width and wherein said single printer page has a page height and a page width wherein one of said page dimensions is at least about twice one of the dimensions of the pages of the network resource.

81. The system of claim 68 wherein said web server dynamically constructs the network resource responsive to the local network device.

82. A system for initiating a print of a network document, comprising:
a local process on a local network device that communicates a set of locally-derived data of the network document to a print configuration process and communicates an identifier of the network document to a print process on a remote network device;
wherein the configuration process creates a print configuration; and
wherein said print process prints the network document responsive to said print configuration.

83. The system of claim 82 wherein said set of locally derived data includes said identifier and said local process communicates said identifier to said print process using said print configuration.

84. The system of claim 82 wherein said set of locally derived data includes a page count for the network resource.

85. The system of claim 82 wherein said set of locally derived data does not include any content of the network resource.

86. The system of claim 85 wherein said configuration process estimates a cost to print the network resource using said set of locally derived data.
